(19) United States
(12) Patent Application Publication
(10) Pub. No.: US 2010/0100845 A1
(43) Pub. Date: Apr. 22, 2010

(54) Organization and Delivery of Information Updates

(75) Inventors: Furqan Khan, Alameda, CA (US); Rikard Kjellberg, Santa Cruz, CA (US)

Correspondence Address: FISH & RICHARDSON P.C., PO BOX 1022, MINNEAPOLIS, MN, 55440-1022, US

(73) Assignee: INGBOO INC., Santa Cruz, CA (US)

(21) Appl. No.: 12/581,680

(22) Filed: Oct. 19, 2009

Related U.S. Application Data
(60) Provisional application No. 61/106,913, filed on Oct. 20, 2008.

(51) Int. Cl. G06F 3/048

(52) U.S. Cl. 715/810

(57) ABSTRACT

Methods and systems for organizing and proactive delivery of information updates from multiple sources are disclosed. Information updates are organized under their respective information topics in an attention list, in which information topics are sorted into ordered attention groups according to their associated attention states. Within each attention group, information topics are further sorted into ordered priority groups according to their associated priority attributes. Within each priority group, information topics are further sorted by age and according to their aging attributes. The attentions states, priority attributes, and aging attributes of information topics are defined by the information delivery system or by individual users. Notifications of new information updates are delivered to a subscriber according to an information delivery schedule.

### CROSS-REFERENCE TO RELATED APPLICATION

This application claims the benefit of U.S. Provisional Application Ser. No. 61/106,913 filed on Oct. 20, 2008, the entire contents of which are hereby incorporated by reference.

### TECHNICAL FIELD

The technology described herein generally relates to Internet services and more specifically to proactive delivery and organization of dynamic information updates for user consumption using online software tools.

### BACKGROUND

Individuals become information consumers when they are exposed to various information sources through their online activities. As the volume of information on the Internet continues to expand, it is increasingly difficult for an individual to identify and act on information that is relevant. It is also difficult for information publishers to capture the attention of information consumers. Information consumers and information publishers both stand to benefit if information is organized and delivered in a way that meets the needs, interests, and current availability and receptiveness of individual consumers.

### SUMMARY

Methods, computer-readable media, and systems enabling organization and proactive delivery of information updates for user consumption using online software tools are disclosed.

In one aspect, a method includes: identifying a plurality of information topics associated with a subscriber, each information topic being associated with a respective attention state and a respective priority attribute, the respective attention state being characterized by subscriber actions toward the information topic, and the respective priority attribute being characterized by the nature of information updates issued for the information topic; organizing the plurality of information topics into an attention list, the attention list being sorted on a first level according to the respective attention states of the plurality of information topics and on a second level according to the respective priority attributes of the plurality of information topics; and presenting the attention list to the subscriber.

In some implementations, organizing the plurality of information topics into the attention list includes: dividing the plurality of information topics into one or more attention groups, each attention group including information topics that share a common attention state, the one or more attention groups being sorted according to a first importance ranking associated with the shared attention states; and for at least one attention group, further dividing the information topics within the attention group into one or more priority groups, each priority group including information topics that share a common priority attribute, the one or more priority groups being sorted within the attention group according to a second importance ranking associated with the shared priority attributes.

In some implementations, each information topic is further associated with a respective age, and organizing the plurality of information topics into the attention list further includes: for at least one priority group, further sorting the information topics within the priority group according to age.

In some implementations, each information topic is further associated with a respective aging attribute, the aging attribute defining whether the order of the information topic is to increase or decrease with age; and the sorting within the at least one priority group is according to both the age and the aging attributes of the information topics within the priority group.

In some implementations, the age associated with each information topic is defined by an arrival time of a most recent information update for the information topic.

In some implementations, the method further includes: for each information topic, determining whether its most recent information update has expired. The determining includes comparing the age of the information update to an attention time window associated with the information update.

In some implementations, the attention time window associated with the information update is user defined.

In some implementations, each attention state is selected from a group including: a New state, a Current state, a Handled state, an Expired state, an Empty state, a Deleted state, and a Tentative state.

In some implementations, the priority attributes of the information topics are adjusted overtime according to aggregated user feedback from multiple subscribers.

In some implementations, the method further includes: generating a notification regarding a newly arrived information update; and delivering the notification to the subscriber according to a notification schedule.

In various implementations, the methods and systems disclosed in this specification may offer one or more of the following advantages.

First, information updates from multiple information sources can be organized under respective information topics in an attention list before the information updates are presented to a subscriber of the information topics. The information topics can be first grouped into attention groups in the attention list based on the attention states of the information topics. The attention state of an information topic can be defined according to the subscriber's previous actions toward the information topic, and the attention states can be ranked to reflect the subscriber's likely receptiveness toward the information topics in each attention state. Therefore, information updates can be presented in an order that is aligned with the subscriber's current receptiveness to information under each information topic.

In addition, within each attention group, the information topics can be further grouped into priority groups, and the priority groups are ranked according to the shared priority attributes of their respective constituent information topics. The priority attribute of an information topic can be based on the nature of the information topic (and/or its information updates) and can reflect the information topic's likely importance and/or relevance to the subscriber. Therefore, information updates can be presented in an order that is further aligned with the subscriber's needs and interest for information under each information topic.

Furthermore, within each priority group, information topics can be further ranked according to the age of their most recent information updates. Some information topics become increasingly important and relevant over time, while others become less important or relevant over time. The change in relevance can be reflected by an aging attribute associated with each information topic. Therefore, information updates can be presented in an order that dynamically reflects the current importance and relevance of each information update to the subscriber.

Based on the methods and systems disclosed herein, attention states, priority attributes, and aging attributes can be system or subscriber defined, and can be adjustable overtime based on subscriber feedback. Moreover, notification of information updates can be delivered according to a subscriber-specific notification schedule, further ensuring that information delivery is dynamically tailored to the needs, interest, and current availability and receptiveness of each subscriber.

The details of one or more embodiments of the subject matter described in the specification are set forth in the accompanying drawings and the description below. Other features, aspects, and advantages of the subject matter will become apparent from the description, the drawings, and the claims.

### DESCRIPTION OF DRAWINGS

FIG. 1A is a schematic of an organization model for information updates.

FIG. 1B is an example attention list embodying the organization model of FIG. 1A.

FIG. 2 is an example network architecture including a server application, a client application, and multiple information sources.

FIG. 3 illustrates relationships between example data entities stored at the server application of FIG. 2.

FIG. 4A illustrates the organization of information topics into attention groups, based on the attention state of each information topic.

FIG. 4B illustrates transitions between example attention states.

FIG. 4C illustrates example processing of an information topic in a Tentative attention state.

FIG. 4D illustrates example processing of an information topic in a New attention state.

FIG. 4E illustrates example processing of an information topic in a Current attention state.

FIG. 4F illustrates example processing of an information topic in a Handled attention state.

FIG. 4G illustrates example processing of an information topic in an Expired attention state.

FIG. 4H illustrates example processing of an information topic in an Empty attention state.

FIG. 5 illustrates an example process for ordering information topics by age.

FIG. 6 illustrates an example process for determining whether an information topic has expired due to its age.

FIG. 7 illustrates an example user notification schedule.

FIG. 8 illustrates an example process for organizing an attention list according to attention groups.

FIG. 9 illustrates an example process for organizing information topics within some attention groups according to priority.

FIG. 10A illustrates an example process for delivering information updates to a subscriber.

FIG. 10B illustrates an example process for organizing information updates in an attention list.

FIG. 11 is a block diagram of an example computing device.

Like reference symbols in the various drawings indicate like elements.

### DETAILED DESCRIPTION

### Overview

The Internet and mobile communication networks offer multiple communication channels, such as web portals, email, Really Simple Syndication (RSS), Short Messaging Systems (SMS) and Multi-Media Messaging (MMS).

Some of these communication channels are proactive (e.g., email, SMS, MMS), or push-based. In a push-based channel, messages are generated at an originating source, assigned a destination identifier (e.g., email address, phone number), and then sent over a communication network to a destination node. The network routes the message and ultimately delivers it to the destination node. The destination node provides a client application (e.g., an email client or SMS client). Once the message has arrived at the destination node, the message is put into a message inbox, typically organized on a first-in-first-out (FIFO) basis.

Some of the communication channels are passive or pull-based (e.g., RSS). An RSS client periodically requests an update from the information source, and retrieves the information update if it is available at the time of the request. No destination identifier needs to be used by the information source. While RSS uses a pull-based channel for information updates, consumers' perception and experience for an RSS client application is not much different from that of push-based technologies like email, SMS, and MMS.

Most client applications provide a way for the user to organize their inbox (e.g., by time, recipient, source, topic, etc.). Messages can be filtered, categorized, and cataloged, based on how the client application is configured. Although these basic organization options make an attempt at reducing clutter and improve organization of the received information, they are inadequate in addressing the need to ensure information relevance and user attention.

Specifically, conventional information delivery systems commonly exhibit the following behaviors:

First, user configuration is often required for organization and filtering. While most client applications allow sophisticated configuration options, these are typically not user-friendly for users who are not technically inclined. The average user will rarely utilize these options since they require detailed knowledge of how the messaging application works. In addition, a combination of different options can become rather involved, and sometimes it is difficult for a user to predict the exact behavior of the configuration he or she has set up. Thus, even when used, these options cause uneasiness and fear of unintended neglect or loss of important information.

Second, message importance is defined by the sending party. In conventional systems, a message that arrives in an inbox may be flagged by the sending party as a high-importance message. This flag is arbitrary and can be used thoughtlessly by the sending party. Consequently, the flag is often ignored by the receiving party. Furthermore, unless specifically configured, message importance set by this flag has no impact on the organization of messages in the inbox.

Third, message importance is static. In conventional systems, once message importance has been set to a specific value, it will remain unchanged. Message importance is not updated even if the message becomes obsolete, more critical, or less important over time. A user has to continually monitor and adjust the importance parameter of each message if she or she wishes to keep this parameter valid over time. This constant manual monitoring is simply infeasible in reality.

Fourth, message ordering is static. In conventional systems, messages are ordered either in a First-In-First-Out (FIFO) manner or as configured by the user (e.g., alphabetically by subject, by sender, and so on). Once a sorting behavior is defined, the ordering of messages will be static. Even if message relevancy or importance changes over time, the ordering of messages will not reflect the change.

Fifth, message expiration is static. In conventional systems, messages may expire based on some configuration parameters. For example, many applications allow a user to set an automatic deletion policy for all messages after a period of time (e.g., three months). This automatic deletion policy can sometimes cause inadvertent loss of relevant information. As a result, automatic deletion or expiration is typically not enabled by users. However, when the expiration feature is under-utilized, the message inbox becomes cluttered with irrelevant messages, which makes it even more difficult for a user to identify what is relevant and afford appropriate attention to the relevant messages.

In addition to messages in an inbox, users sometimes visit web portals for information on specific topics. Users can subscribe to certain topics on the web portals, and have updates under those topics delivered to the user as the updates become available. Users can also personalize an account at a web portal, and thus customize the content and layout of web-based content at the web portal for personal viewing. Personalized portals typically organize information by topic (e.g., sports, news, and finance). Each topic occupies a dedicated space on the portal interface. The subscribed topics reflect the subscriber's needs and interest to some extent. However, organization of information updates by topics in a personalized portal interface is counter-intuitive because once information updates arrive at the personalized portal, the subscriber is more concerned with information relevancy, rather than its topic.

Organization of information updates only by topic is inadequate also because the topics are independent, and are updated in an un-coordinated fashion. Even though the subscribers can mentally attach different priority and importance to each information topic (or specific information updates) at different times and under different context, such mental activities are not reflected by the topical organization. Thus, relevance and user attention are not ensured in such conventional systems.

This specification describes a conceptual model and some example implementations for attention and relevancy-based organization of dynamic information. The organization of information updates takes into account both the current availability and receptiveness of the subscriber, and the relevance and importance of the information updates. Furthermore, the organization is dynamically adjusted over time to reflect the change in message relevance, importance, and user attention and receptiveness over time. A user-specific notification schedule can be used to ensure that notifications of information updates can be delivered at times that are appropriate for different types of information updates and are not distracting or disruptive to the user.

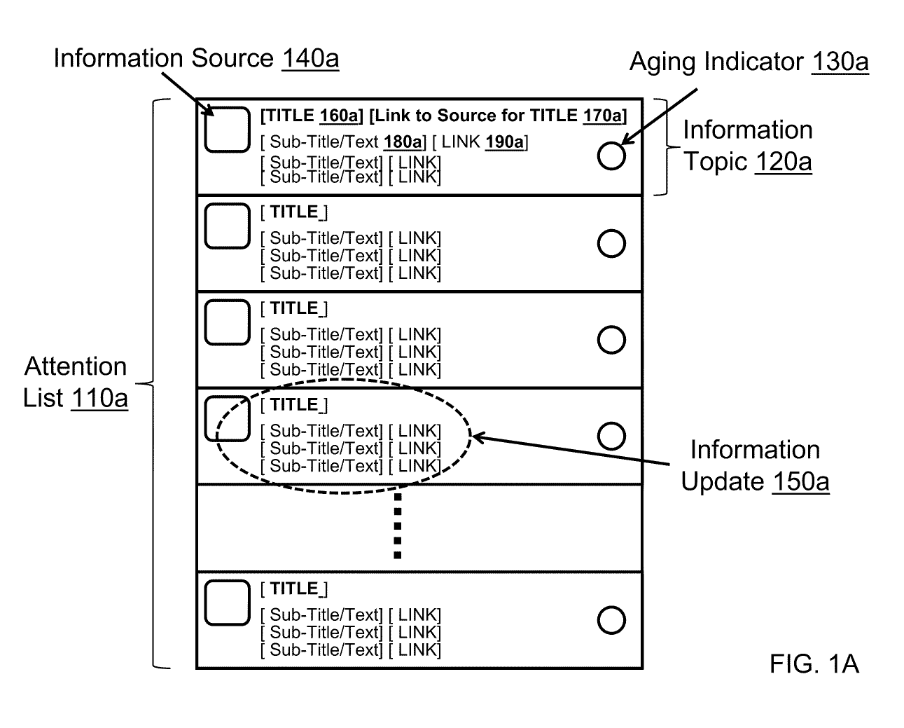

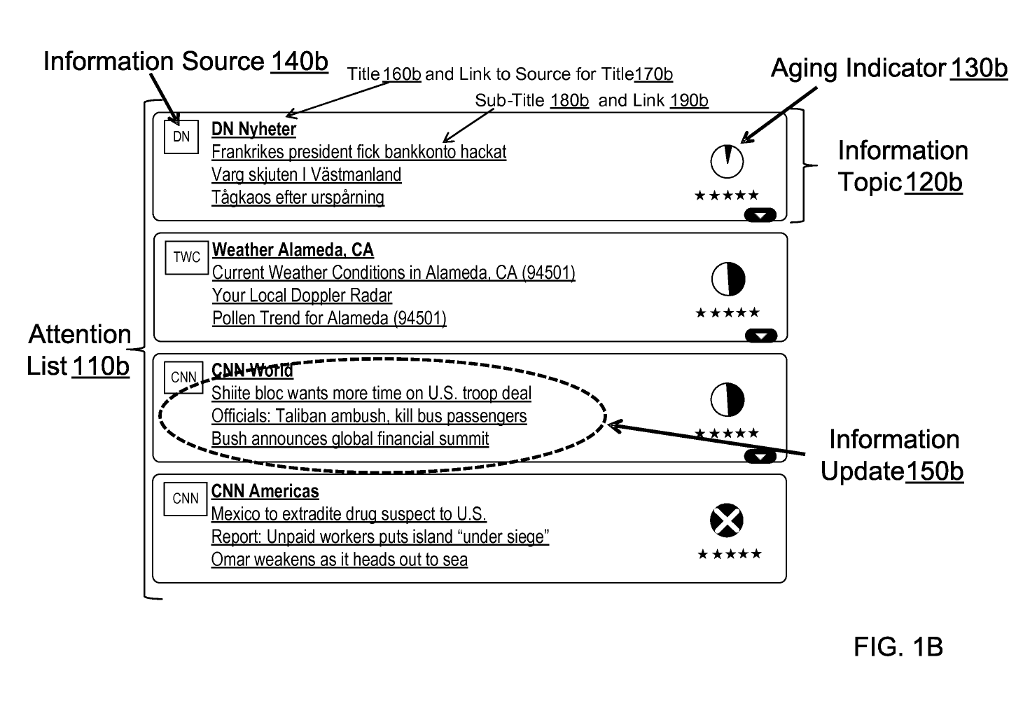

FIG. 1A is a schematic of an example organization model for information updates. A user can subscribe to multiple information topics from multiple information sources. These information sources generate information updates that are delivered to the subscriber through various communication channels. A server application can be used to funnel these information updates on behalf of the subscriber, and organize the information updates in an attention list before presenting the information updates to the subscriber.

One objective of the example organization model in FIG. 1A is to provide the subscriber with a list (e.g., attention list 110a) of information updates that are organized by relevancy, thereby ensuring the subscriber's appropriate attention to the information updates.

The attention list 110a can display a sequence of information topics (e.g., information topic 120a), each information topic connecting the subscriber with an information source (e.g., information source 140a). Through a server application interface, the subscriber can add one or more information topics he or she has previously subscribed in a personalized attention list, or create a new attention list by subscribing to various information topics through the server application interface. The attention list 110a thus reflects an organized inventory of the information topics for which the subscriber has agreed to receive information updates.

Information updates (e.g., information updates 150a) can be routed to subscribers based on their individual subscriptions. Each information update can be related to exactly one information topic. Multiple users can subscribe to the same information topics. In some implementations, each information topic can receive information updates from a single information source or multiple information sources. Each user can be uniquely associated with a single personalized attention list.

An information topic, as displayed in the attention list 100a can contain the most recent information updates 150a posted to that information topic 120a. In some implementations, only a single most recent information update is displayed under each information topic in the attention list 100a. Previous information updates can be preserved in addition to the most current update and made available upon subscriber request (e.g., by clicking on a link for additional updates).

Since the information topics are ordered in the attention list 110a, the positions of the information topics can have a direct impact on where information updates under each information topic show up in the attention list.

On the other hand, information updates age over time, and the age of an information update can impact the positions of information topics in the attention list as well. For example, if an information update expires, the information topic containing the expired information update can be moved down towards the bottom of the attention list. For another example, certain information topics, such as news, become less important over time, while others, such as calendar items or sale ads, become more important over time before they expire.

Consequently, the attention list is a dynamic list where information topics (and their information updates) compete for top positions based on multiple characteristics, some of which are static while others are dynamic. To enable automatic organization and prioritization of information topics within the attention list, a number of characteristics can be defined for each information topic (and their information updates). The characteristics can reflect the context surrounding the information updates, such as time, information category, information status, user availability, user preferences, and so on.

For example, a priority attribute can be defined for each information topic to indicate the importance of the information topic to the subscriber. The priority attribute can be determined based on nature of the information topic (e.g., as reflected by the information category of the information topic). For example, emergency alerts can be assigned a higher priority than important news, while important news can be assigned a higher priority than sales ads, and so on.

For another example, each information topic can be associated with an aging attribute. The aging attribute can be determined based on the nature of the information topic (and their updates) as well. For example, sales news becomes more important as it ages (before expiration) while regular news becomes less important. The aging attribute of an information topic can be used to determine if the information topic shall be above or below another information topic with a more recent information update.

For another example, each information update can be associated with an attention time window (ATW). The ATW defines how long an information update is relevant and when it expires. The ATW can be user-defined, sender-defined, or system-defined. For example, sales news can have a sender-defined expiration date while regular news can have a user-defined or system-defined expiration date. Once an information update expires (e.g., when its age exceeds its ATW), it can be moved to the bottom of the attention list (1) and out of view for the subscriber. In some implementations, the age of an information topic can be indicated by an aging indicator 130a to the subscriber.

In addition to proactively viewing the attention list, a subscriber can also define a notification schedule for information updates to be delivered to the subscriber at appropriate times. The notification schedule can be defined in terms of one or more information consumption characteristics. For example, the subscriber can specify that notifications of information updates are only allowed during certain days or certain times of the day, or only if the priority of the information update is above certain thresholds. The combination of attention list and notification schedule ensures that the most relevant information updates are presented to the subscriber in a timely fashion, when the subscriber is receptive and can allocate the appropriate amount of attention to the information updates.

The information update notification and attention list can further include a summary for each information update. Each information update can include a title 160a and one or more sub-titles 180a. The title 160a may include an embedded reference 170a (e.g., a link) to more information or full details for the title. A sub-title 180a may include an embedded reference 190a for more information or full details for the sub-title.

FIG. 1B illustrates an example embodiment of the organization model shown in FIG. 1A. In FIG. 1B, the attention list 110b can be presented on an interface of the server application (e.g., a webpage of the server application). In this particular example, the subscriber has subscribed to a number of information topics 140b (e.g., CNN news in entertainment, CNN news in the Americas, Slashgear gadget reviews, and CNN business traveler blog) from several information sources (e.g., “CNN.com” and “Slahsgear.com”). The information updates 150b (e.g., news articles, reviews, and blog posts) are received for each information topics 140b, and are presented in the attention list 110b. The information source of each information topic can be indicated on the attention list as an icon or logo 140b. Each information topic can be identified by the title 160b and a link 170b that leads to addition information about the information topic. Information updates are indicated under the information topic by sub-titles 180b and links 190b for additional information and full details of the information updates. An aging indicator 130b can be presented for each information topic that indicates how current the information updates are or how close the topic is to expiration. Other embodiment of the attention list can be implemented.

### System Architecture Overview

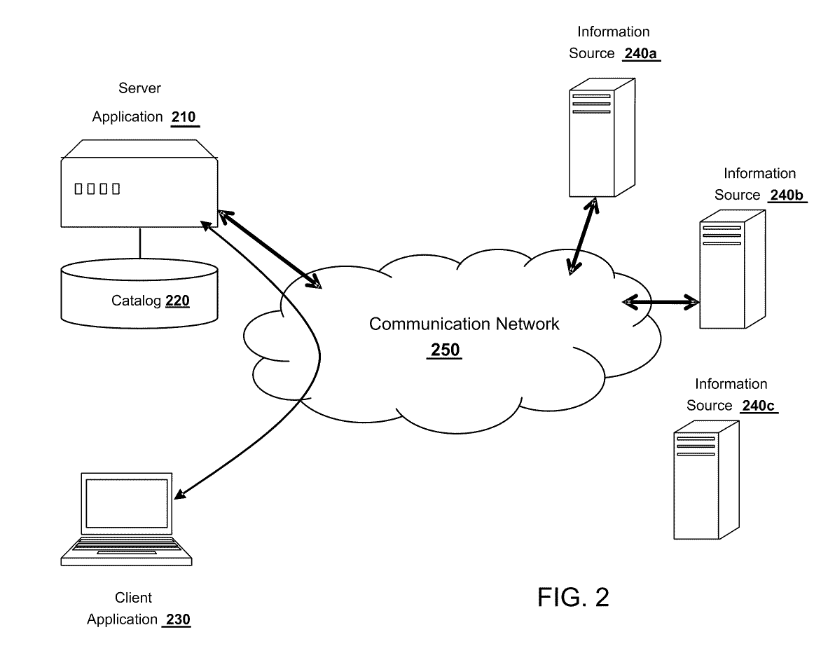

FIG. 2 illustrates example system architecture for propagating dynamic information from information sources to a subscriber. The system include information sources 240 (e.g., 240a-240c), a server application 210, and a client application 230. The server application 210 can server multiple client applications. The information source 240 can publish information updates for multiple information topics. The subscriber can subscribe to multiple information topics at each of multiple information sources, either directly or through the server application 210. The server application 210 has access to a catalog 220 that stores various user data, subscription and configuration information for subscribers. The client application 230 and the server application 210 communicate through a communication network 250.

The Communication Network 250 can be the Internet or any other network suitable for data communication. Information sources 240 publish information or make their data available for external access. Examples of information sources include web sites (e.g., CNN.com, weather.com, slashgear.com, etc.) and RSS servers. The server application 210 can receive or retrieve information updates from the multiple information sources 240 on behalf of the subscriber and funnels the information updates to the client application 230 according to the subscriber's subscription and configuration information. The information updates can be proactively pushed to the server application 210 by the information sources 240 or periodically pulled from the information sources 240 by the server application 210. Alternatively, the server application 210 can retrieve published data from the information sources 240 and determine whether to generate an information update for the subscriber.

The server application 210 can manage an attention list for each subscriber, and provides an interface (e.g., a website) for user access. The subscriber accesses the attention list via the client application 230 (e.g., a web browser). The subscriber receives information updates via the attention list. An example server interfaces can be implemented using the Hyper Text Markup Language (HTML) for display and Hyper Text Transport Protocol (HTTP) for data transport. Examples of the client application can include various web browsers or messaging clients. The client application 230 provides a human readable form of the information updates to the subscriber.

### Example Implementation of the Attention List

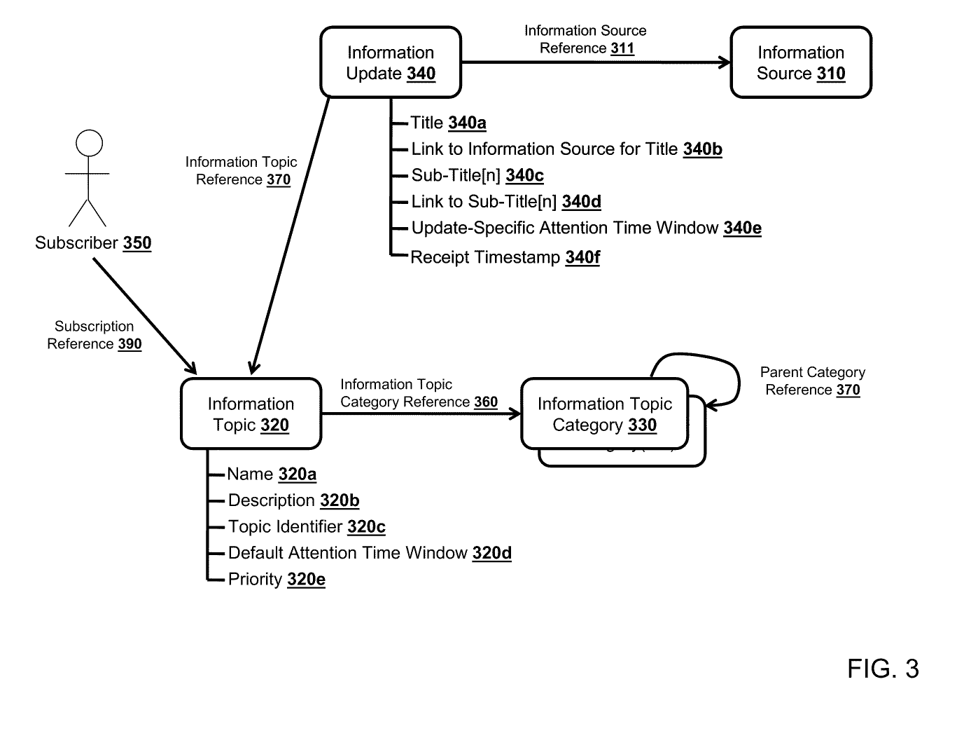

FIG. 3 illustrates relationships between example data entities stored at the server application of FIG. 2 (e.g., in catalog 220). A subscriber 350 is linked to an information topic 320 through a subscription reference 390. The information topic is linked to an information topic category 330 through an information topic category reference 360. An information update 340 is linked to an information topic 320 through an information topic reference 380 and to an information source 310 through an information source reference 310. Each information topic 320 is further associated with a number of topic attributes (320a-320e). Each information update 340 is further associated with a number of update attributes (340a-340f).

In the example shown in FIG. 3, the information source 310 is where information updates 340 originate. In the case of Internet applications, a web portal or website can be an example of an information source 310.

An information topic 320 can be represented by a single entry in the attention list. The information topic 320 can be defined by the values of a number of topic attributes: such as a name 320a, a description 320b, a topic identifier 320c, a default attention time window (ATW) 320d, and a priority 320e.

The name attribute 320a can be a short descriptive term or phrase for the information topic 320. The description attribute 320b can be a brief description of the information topic 320. The topic identifier 320c can be an identifier, uniquely identifying and distinguishing this information topic from other information topics. The default attention time window (ATW) 320d can be a value that specifies how long an information update under the topic is valid before the topic expires. The ATW can be expressed in any suitable time unit (e.g., seconds, minutes, hours, days, weeks, months, years, and so on). The ATW can also be specified in terms of a date or a condition for expiration (e.g., Jul. 10, 2009 or until the completion of a particular task). The value of a default ATW can be overridden by an information update that has an update-specific attention time window 340e.

The priority attribute 320e can be used to indicate the relative importance of the information topic and corresponding information updates based on the nature of the information topic or updates. Examples of priority values include: “High, Medium, and Low,” “levels 1 through 5,” “Critical Alert, High Alert, and Routine” and so on. The priority value for each information topic can be specified by the subscriber, or by the server system based on common sense or common user experience. For example, severe weather alert can be given a higher priority than entertainment news and regular weather forecast, while breaking news can be given a higher priority than regular news, and so on.

The list of topic attributes listed above is are mere examples and may vary according to the context of specific implementations. For example, in some implementations, a subscriber can set a user-assigned name for the information topic. The information topic can further be associated with an aging attribute which describes how age of the information topic may affect its importance or its priority in the attention list.

An information topic 320 can be assigned an information topic category 330. Organizing information topics under different categories allow users to browse the overall inventory of available information topics to which the users can subscribe. Examples of information topic categories include, but are not limited to, business updates, world news, laptop deals, and blog updates, and so on. The list of information topic categories and subcategories may vary according to the context of the specific implementations.

An information update 340 can be associated with exactly one information topic 320 as defined by an information topic reference 380. Each information update 340 can be associated with a number of update attributes, such as a title 340a, a link 340b for the title, one or more subtitles 340c, one or more links 340d for the subtitles, a user-specific attention time window 340e, a receipt timestamp 340f, and so on.

The title attribute 340a can be a text string that describes the information update or gives the subscriber some context about the information update. The link 340b for the title can be a reference back to the main repository for the information source that supplied the information update. In the case of a web site, this link allows a client application to navigate back to the main page of the information source 310. The sub-title(s) 340c can be short descriptive titles for multiple messages or items in an information update. For each sub-title 340c, a link 340d can be provided that allows a client application to navigate to sub-segment of the information source. In the case of a web site, this could be a page containing specific information regarding a subject or message contained in the information update.

An update-specific attention time window 340e can be associated with each information update 340. In some implementations, if the update-specific ATW is not specified or set to zero, then the default ATW 320d for the information topic can be used. The receipt timestamp 340f can be defined as the time at which the information update 340 was received and inserted into the attention list.

The update attributes listed above are mere examples, and may vary according to the context of specific implementations.

The relationships between the data entities relevant for the attention list are represented by a number of references parameters, including the information topic category reference 360, the parent category reference 370, the subscription reference 390, an information topic reference 380, and an information source reference 340.

The information topic category reference 360 can specify a unique information topic category 330 describing the nature of the information updates 340 that are posted for this information topic 320. Examples of information categories include, but are not limited to: business updates, world news, laptop deals, blog updates, and so on.

The information topic category 330 can have a parent category. The patent category can be indicated by the parent category reference 370. By allowing a hierarchical category structure, users can easily browse and discover information topics of his or her interest in a systematic way. If the parent category reference 370 for an information topic category 330 is specified, the information topic category 330 is a sub-category of some parent category. Otherwise, the information topic category 330 is a top-level category.

The information topic reference 380 associated with an information update 340 can identify the information topic with which the information update 340 is associated. The subscription reference 390 associated with an information topic can identify the subscribers that are currently subscribing to the information topic. Alternatively, the subscription reference associated with a subscriber can identify the information topics to which the subscriber is currently subscribing. The subscription reference 390 can facilitate the routing of information updates to individual subscribers' attention lists. The information source reference 310 associated with an information update can identify the source from which the information update 340 originated.

The list of references listed above are mere examples and may vary according to the context of specific implementations.

The attention list for a subscriber can be generated and sorted according to an organization process. The attention list organization process dynamically organizes information topics in the attention list by relevance. In the organization process, attributes of the information topics and information updates, as well as other timing, context, rules, and preferences can be utilized to ensure the most relevant and important updates are ranked higher in the attention list.

Notifications for information updates can be generated according to a notification process. A notification schedule can be used to determine when to generate a notification of information updates to the subscriber such that the notification are not disruptive and can be afforded proper attention by the subscriber.

A personal attention list can be created when a subscriber specifies, through the server application interface, the information topics to which he or she has subscribed or wishes to subscribe. The attention list can contain any number of information topics. Each information topic represents a subscription to information updates that originate from an information source.

Information updates can occur at any time and at any frequency. The attention list thus evolves over time, in a dynamic fashion as the following events take place (not necessarily in this order): (1) subscribers subscribe to information topics; (2) subscribers cancel information topic subscriptions; (3) subscribers assign or change priority to information topics; (4) information sources send information updates for information topics; (5) information updates age over time; (6) information updates expire after some time; (7) new information updates arrive and replace prior updates for an information topic; and so on.

In some implementations, the attention list can be organized in three steps: (1) by attention state, (2) by priority; and (3) by age. In some implementations, the placement of information topics and information updates in the attention list can be dynamically determined by carrying out the organization process at periodic intervals. In some implementations, the organization process can be carried out when a subscriber is requesting access to the attention list. In some implementations, the organization process can be carried out every time the server application sends a user notification to a subscriber. The user notification informs the subscriber that there are one or more information updates for information topics in the attention list. In some implementations, not all three steps are performed or necessarily in this order.

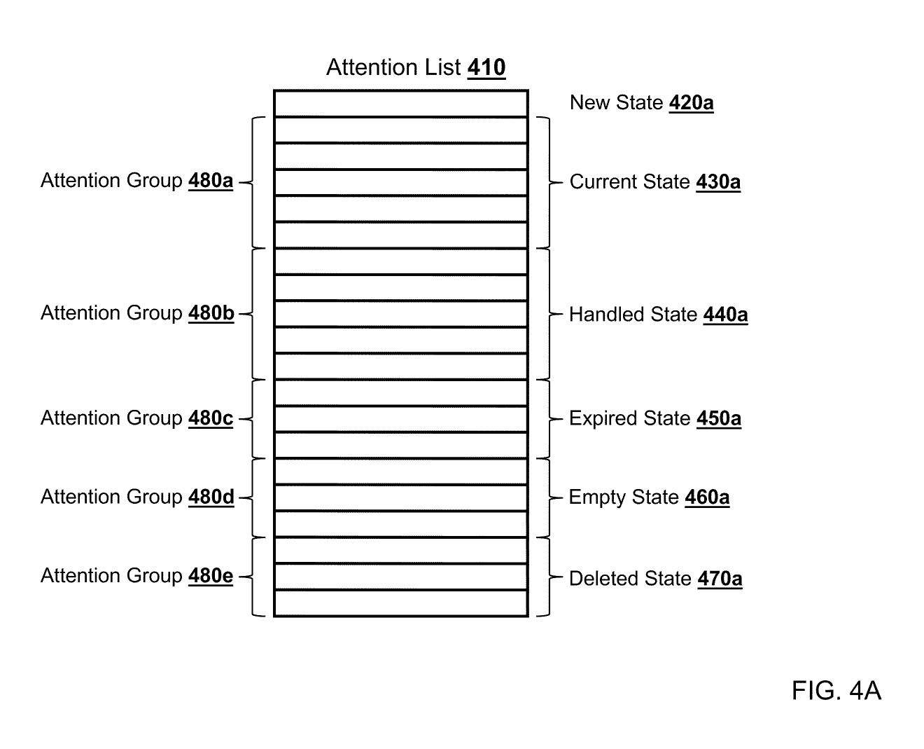

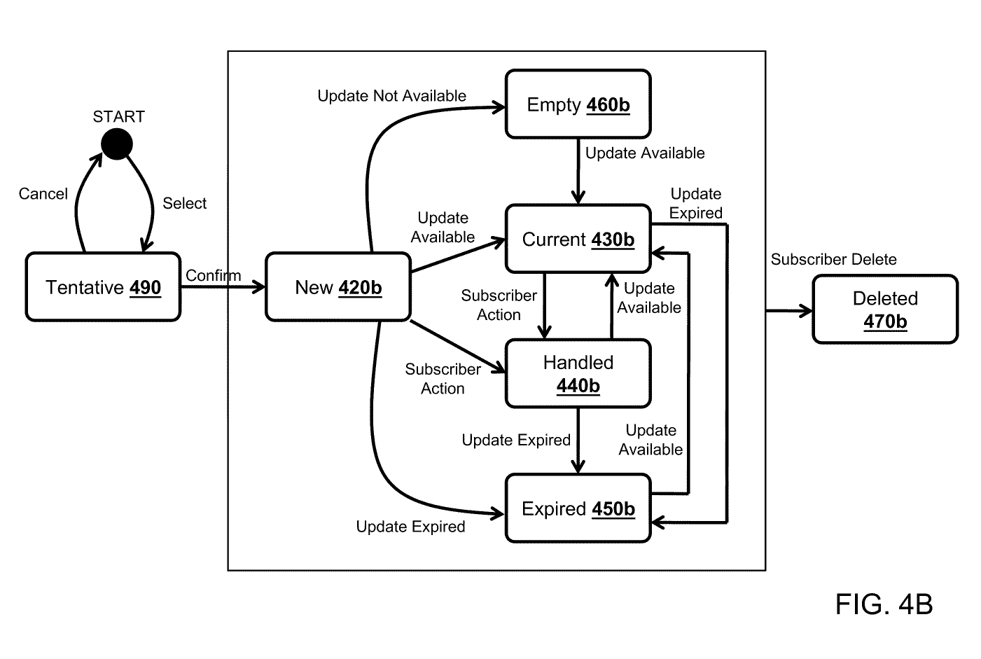

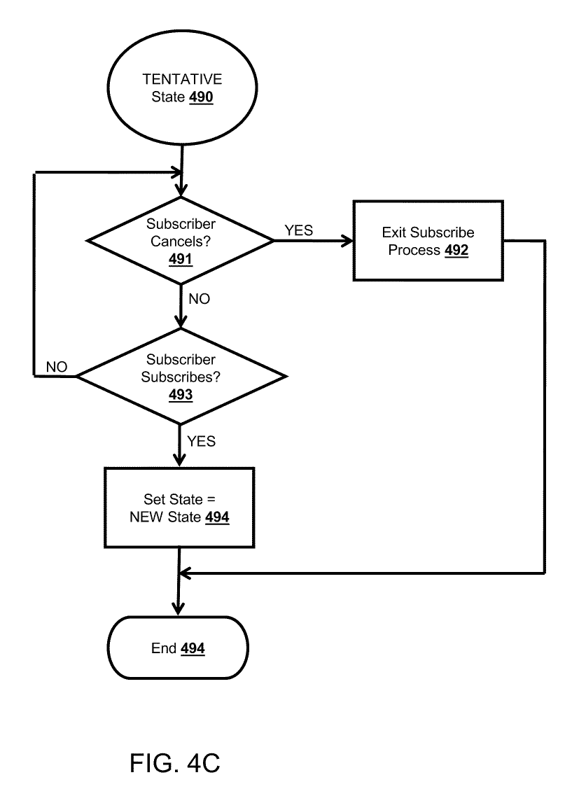

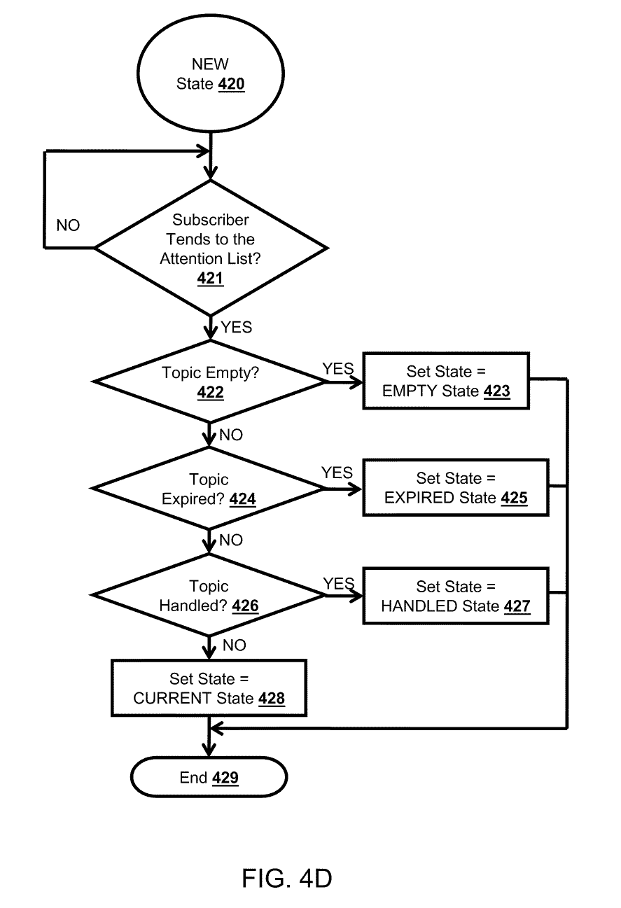

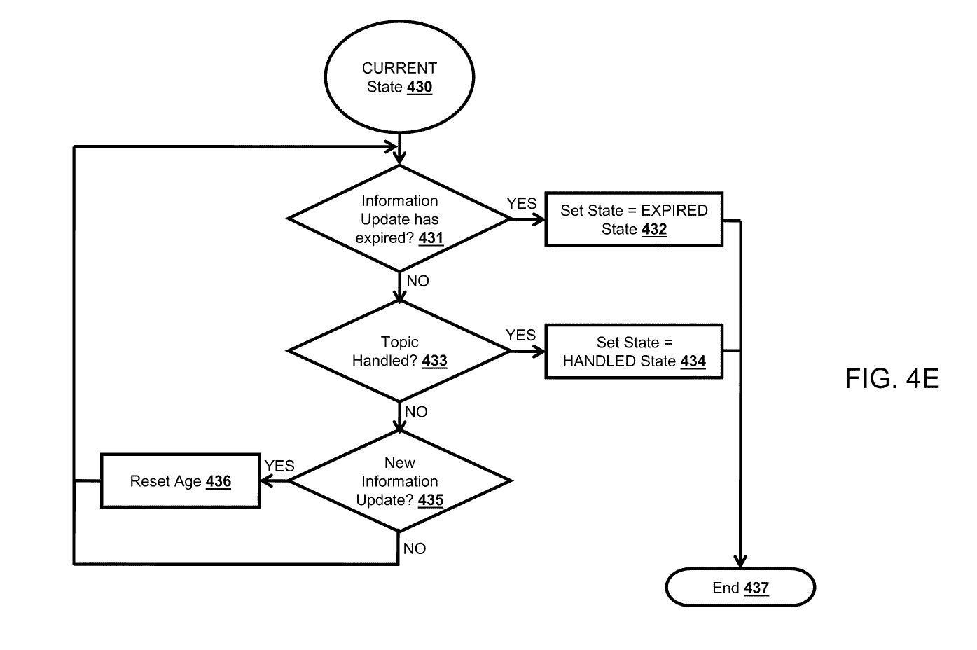

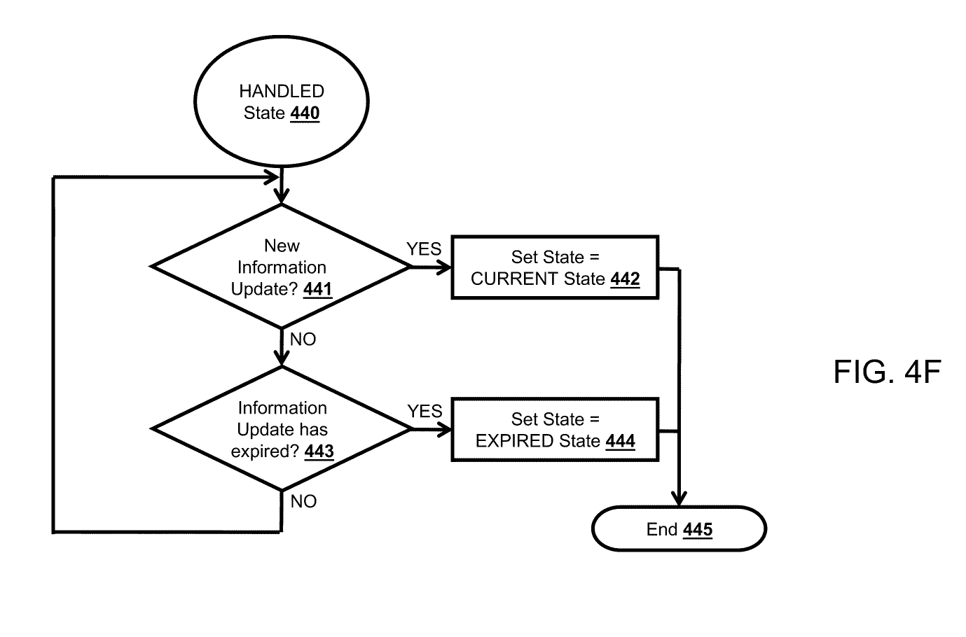

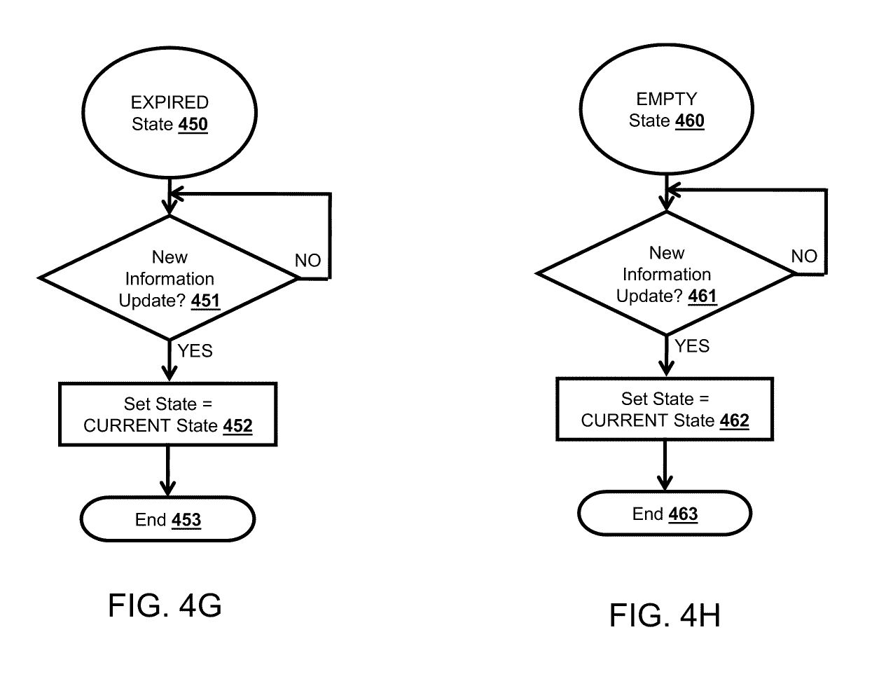

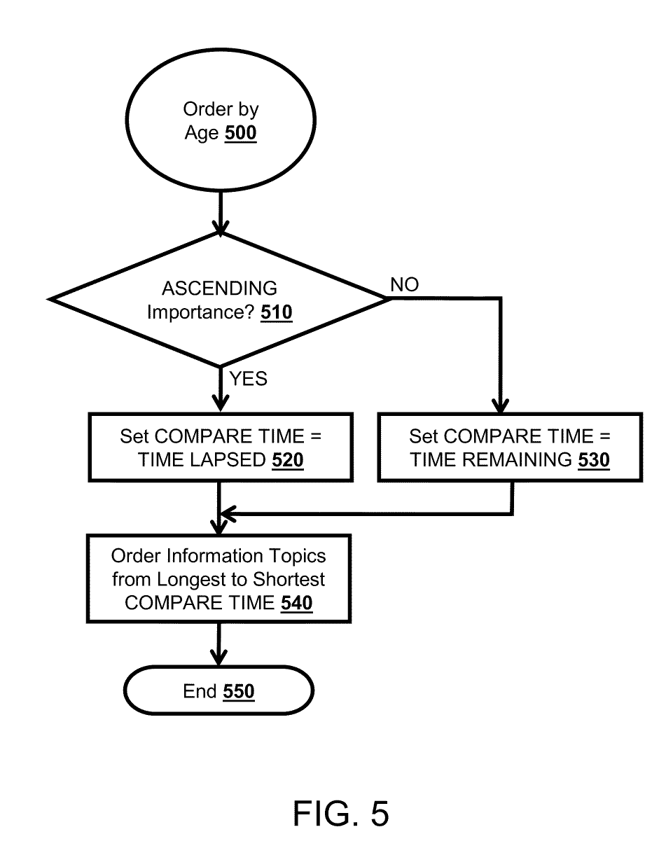

FIG. 4A is a schematic illustrating the organization of information topics into seven example attention groups, based on the attention state of each information topic. FIG. 4B illustrates the transitions between the seven example attention states of FIG. 4A.

In an example implementation, information topics can be organized into attention groups based on the attention state of each information topic in the attention list 410. Each attention group (e.g., 480a-480e) can include the information topics that share a common attention state (e.g., 420a, 430a, 440a, 450a, 460a, and 470a) associated with the attention group. The attention groups can be ranked in a descending order in the attention list by attention state as follows: (1) New 420a, (2) Current 430a, (3) Handled 440a, (4) Expired 450a, (5) Empty 460a, and (6) Deleted 470a. Information topics can also have a Tentative attention state (not shown). The Tentative attention state represents a transitional state of an information topic when it is selected by a subscriber but not yet formally subscribed to by the subscriber. In this example, information topics in the Tentative attention state are excluded from the attention list.

The transitions between the example attention states are illustrated in FIG. 4B. When a user selects an information topic through the server application interface, the information topic enters a Tentative attention state 490 for the user. If the user subsequently cancels the selection, the information topic exits the Tentative attention state 490 and becomes unassociated with the user. However, if the user subsequently confirmed the selection for subscription, the information topic enters the New attention state 420b. The information topic in the New attention state can subsequently enter the Empty attention state 460b, the Current attention state 430b, the Handled attention state 440b, and the Expired attention state 450b, depending on the availability of information updates and subscriber actions toward the information topic or attention list. The processing of the information topic in the New attention state 420b is described in more detail with respect to FIG. 4D. An information topic in the Current attention state 430b can transition into the Expired attention state 450b, and vice versa, depending on the availability of new information updates under the information topic. The subscriber can delete an information topic at any time, therefore, information topic in any of the above subscribed states can enter the Deleted attention state 470b when the subscriber cancels the subscription to the information topic.

The attention states listed above are mere examples. Specific implementations may include more or fewer attention states, different attention states, different hierarchical organization of attention states, or different transitions between attention states, and are not limited to the examples described herein.

FIG. 4C illustrates example processing of an information topic in the Tentative attention state 490. When a subscriber chooses an information topic for subscription, an instance of the information topic can be created and tentatively associated with the subscriber. The information topic can be assigned the Tentative attention state. If the subscriber cancels the selection (491), the process terminates and the instance of the information topic is deleted (492). If the subscriber does not cancel and ultimately confirms the subscription (493), the attention state of the information topic can be reset to the New attention state (494). Once the information topic enters the New attention state, it can be placed in the attention list of the subscriber, and the processing of the information topic in the Tentative attention state is completed (494).

FIG. 4D illustrates example processing of an information topic in the New attention state 420. The New attention state can indicate a newly subscribed information topic. When displaying the attention list, (e.g., as part of the subscription process), the information topic that is newly subscribed can be placed at the top of the attention list. Placing the newly subscribed information topics at the top of the attention list is appropriate because a subscriber typically wishes and expects to see the newly subscribed information topic appear in his or her attention list regardless of the status of any information updates for the information topic. Therefore, listing the information topics in the New attention state higher in the attention list is aligned with the user's likely attention and receptiveness.

After the subscriber has accessed the attention list after the new subscription (421), the newly subscribed information topic can exit the New State. Subsequent subscriber actions and status of information updates for the newly subscribed information topic can be determined for placement of the information topic in the next attention state.

If the information topic does not have any information updates (e.g., if the information topic is empty 422), the attention state of the information topic can be reset to Empty (423).

If the information topic is not empty, then it is determined whether information updates in the information topic have expired (424). If the most recent information update in the information topic has an age that exceeds the attention time windows of the information topic, then the attention state of the information topic can be set to Expired (425).

If the information topic is not empty and the information topic has not expired, then it can be determined whether the information topic has been handled by the subscriber (426). The information topic is handled, for example, when the subscriber has accessed the information topic after the information updates have been received. If the information topic has been accessed after the most recent information update, then the attention state of the information topic can be set to Handled (427).

If the information topic is not empty, not expired, and has not been accessed after the most recent information update, then the attention state of the information topic can be set to Current (428).

Once the attention state of the newly subscribed information topic has been set to either the Empty attention state, the Expired attention state, the Handled attention state, or the Current attention state, the processing of the information topic in the New attention state is completed (429).

At any time, the subscriber may cancel the newly subscribed information topic, and the attention state of the information topic can be changed to the Deleted state if the cancellation occurs, irrespective of the conditions or status of the information topic and information updates under the information topic.

FIG. 4E illustrates example processing of an information topic in the Current attention state 430. An information topic can retain a Current attention state when its most recent information update has not expired (e.g., its age does not exceed its ATW) and the subscriber has not accessed the information topic since the arrival of the most recent information update of the information topic. Information topics in the Current attention state can be placed immediately below the information topics that are in the New attention state. The information topic exits the Current attention state and enters the Expired state when all of its information updates age beyond its attention time window (ATW). The information topic exits the Current attention state and enters the Handled state when there is subscriber action (e.g., the subscriber clicking on a topic link) toward the information topic while the information topic is in the Current attention state. In some implementations, the system can resets the attention state of the information topic to Expired (432) if the most recent information update for the information topic has expired (431). If the information update has not expired, the system can check to see if the subscriber has accessed the information topic since the most recent information update (433). If the subscriber has accessed the information topic since the most recent information update, the system can set the attention state of the information topic to Handled (434). The system can also check for new information updates for the information topic. If there is new information update available for the information topic, the system can reset the age of the information topic (e.g., using the receipt timestamp of the new information update), and recalculate the attention time window of the information topic (436).

If the attention state of the information topic is changed to either the Expired or the Handled attention state, the processing of the information topic in the Current attention state is completed (437). If the attention status of the information topic is not changed into either the Expired or the Handled attention state, the information topic can remain in the Current attention state. If the subscriber deletes the information topic at any time, the attention state of the information topic can be changed to the Deleted state.

FIG. 4F is a flowchart illustrating example processing of an information topic in the Handled attention state 440. The Handled attention state associated with an information topic can indicate that the subscriber has accessed the information topic after the arrival of the most recent information update for the information topic. The subscriber actions that would be considered as an access to the information topic can include, for example, acknowledging that the information is received, branching from the information update to the information source via a link in the information update, or other application-specific actions (e.g., accepting a meeting request, saving an information update for later viewing, and so on).

Information topics in the Handled attention state are placed below the information topics in the Current attention state in the attention list. Frequently, after a subscriber has accessed the most recent information updates under an information topic, the subscriber's attention is no longer focused on the information topic until new updates are received for the topic. However, sometimes, the subscriber may still wish to revisit an information update at a later time (e.g., when he or she has more time, or when all resources for dealing with an update become available). Therefore, placing the information topics in the Handled attention state in the attention list, but not at the center of attention is aligned with the needs, interest, and receptiveness of the subscriber.

For an information topic in the Handled attention state, the server can continue to check for new information updates available for the information topic (441). If new information update becomes available, the attention status of the information topic can be reset to Current (442). If no new information update is available, the server can determine whether the existing information update has expired (443). If the existing most recent information update of the information topic has expired, the attention state of the information topic can be reset to Expired (444).

After the attention state of the information topic is changed to either the Current state or the Expired state, the processing of the information topic in the Handled attention state is completed (445). The subscriber can also delete the information topic at any time, and the attention state of Handled State (4.4) can be changed to the Deleted state.

FIG. 4G is a flowchart illustrating example processing of an information topic in the Expired attention state 450. When the most recent information update of an information topic has aged beyond its attention time window, the information topic expires (i.e., it is deemed no longer relevant). Other definitions for the Expired state are possible for specific implementations. The information topics in the Expired attention state can be placed below the information topics in the Current attention state in the attention list. This arrangement is aligned with the subscriber's attention and receptiveness to the information topics because the subscriber is typically not as concerned with old information as he or she does with current information.

When the information topic is in the Expired attention state, the server can continue to check whether any new information update has become available for the information topic (451). When a new information update becomes available for the information topic, the server can reset the attention state of the information topic from Expired to Current (452). Once the attention state of the information topic changes to the Current state again, the processing of the information topic in the Expired state is completed (453). The subscriber can also choose to delete the information topic at any time, and the server can change the attention state of the information topic from Expired to Deleted if the deletion occurs.

FIG. 4H illustrates example processing of an information topic in the Empty attention state 460. After the information topic has been subscribed and the subscriber has accessed the information topic since the subscription, the information topic is no longer in the New attention state. The server can first check to see if any information update is available for the information topic (461). If no information updates has been received for the information topic and there is no historical and expired updates to populate the topic with, then the information topic is empty and remains in the Empty attention state.

Information topics in the Empty attention state can be placed below the information topics in the Current and the Expired attention states, because there is no need for the subscriber to pay attention to these empty information topics. The placement of the information topic in the Empty state is thus aligned with the needs and interests of the subscriber.

When a new information update is received for the information topic, the server can reset the attention state of the information topic from Empty to Current (462). The age of the information topic can be updated with the receipt time of the information update. When the attention state of the information topic is reset to Current, the processing of the information topic in the Empty state is completed (463). If the subscriber deletes the information topic at any time, the information topic can enter the Deleted attention state.

As previously shown in FIG. 3, one of the attributes of an information topic is priority. Priority of an information topic can be based on the nature of the information topic and/or its information updates. An information topic can be associated with an information topic category that characterizes the information topic and/or its information updates, and the priority of the information topic can be set based on the information topic category. Table 1 lists some examples of information topic categories and associated priority levels. Other example topic attributes are also listed.

TABLE 1
Priority of Information Topics

| Information Topic | | | Typical | Aging | Notification |
|---|---|---|---|---|---|
| Category | Priority | Examples | ATW | Attribute | Schedule |
| Critical Alert | 1^{st} | suspicious credit | Infinite | Ascend | Immediate |
| | | card use, burglar | | | |
| | | alarm | | | |
| High Alert | 1^{st} | Neighborhood | Day(s) | Descend | Immediate |
| | | crime | | | |
| Alert | 2^{nd} | sale on a product | Day(s) | Descend | Immediate |
| Exception | 2^{nd} | Weather | Mins/Hours | Descend | Immediate |
| | | exception, traffic | | | |
| | | exception | | | |
| Important | 3^{rd} | finance news | Day(s) | Descend | Per user |
| News | | | | | schedule |
| Regular News | 4^{th} | world news | Day(s) | Descend | Per user |
| | | | | | schedule |
| Promotion | 3^{rd} | time-limited | Day(s) | Ascend | Per user |
| | | product offer | | | schedule |
| Update | 4^{th} | new upgrade for | Week(s) | Descend | Per user |
| | | an application | | | schedule |
| Schedule | 3^{rd} | doctor's | Day(s) | Ascend | Per user |
| | | appointment, | | | schedule |
| | | birthday | | | |

For example, some example information topic categories include: critical alert, high alert, alert, exceptions, important news, regular news, promotions, update, schedule, and so on. Other information topic categories can be defined to suit the needs of individual subscribers. For example, a subscriber can define an information category called “community events,” and assigns a corresponding priority to it.

Information topic categories can be subdivided into hierarchies of sub-categories, each having the same priority or different priority attributes. For example, the subscriber-defined category “community events” can include subcategories such as “city events” and “neighborhood events.” In some implementations, the subscriber can assign different priority levels for each of the subcategories for comparison with other information topic categories. In some implementations, a relative priority is assigned to the sub-categories for comparison within the parent information topic category. The relative priority will not change the position of the information topic as compared with another information topic of a different category, but will affect its position as compared to another information topic of the same category but different sub-category.

As shown in Table 1, examples of the information topics in the critical alert category include: report on suspicious credit card use, burglar alarm setoff, and so on. Examples of the information topics in the high alert category include: neighborhood crime report, and so on. The critical alert category and high alert category are used to characterize information topics that need and warrant subscriber's immediate attention. For example, a user would want to be notified of suspicious credit card use or neighborhood crimes as soon as possible, and take appropriate actions accordingly. These two categories can be assigned the highest priority level among all information topic categories.

Examples of the information topics in the alert category include: sale of a product. The alert category can be defined by the subscriber or by a system administrator. For example, the user can assign the information topic “sale announcements from my favorite store” into the alert category because he or she wants to be notified of the sales as soon as possible, but such notification is probably not as important as the critical alerts and high alerts she may receive. Other alerts include, for example, a garage maintenance announcement for the office, and so on.

Similar to alerts, an exception category can include information topics such as weather exceptions, traffic exceptions, and so on. If a subscriber subscribes to weather and traffic information, he or she may be interested in knowing the most updated information on the weather and traffic exceptions (e.g., storm warning, severe weather alert, accidents, road closing, bridge maintenance, train delays, alternate routes, and so on). Alerts and exceptions can both be assigned a high priority, but maybe not the highest priority among all information topic categories.

Other information topics that may be of interest to the subscriber, but may not be as time sensitive or important to the subscriber, include for example, news, sales, update, and calendar items. Categories for these topics can include, for example, important news, regular news, promotions, update, and schedules. These categories can be associated with lower priorities than the critical alert, high alert, alert, exception categories.

Examples of important news can include finance news (e.g., large stock price change, mortgage rate change, and so on). Important news can also be defined as breaking news. Regardless of a subscriber's particular areas of interest, breaking news or important news may be relevant to the subscriber's situation given the severe nature and general applicability of the news events. Examples of regular news can include world news, entertainment news, sport news, and so on. Regular news is of interest to the subscriber, but may not have a high priority to the subscriber.

The promotions category can be used to characterize different sales or promotion announcements that the subscriber has elected to receive from different information sources. The schedule category can include event reminders (e.g., doctor's appointment, or birthdays), calendar invitations (e.g., meeting request), and so on. The update category can include notifications of software upgrades for various software applications that the subscriber has installed. Promotions and schedules are events that the subscriber may wish to attend at a convenient time, but at the same time, they require subscriber's attention within a finite amount of time. Therefore, promotions and schedules y may be associated with a slightly higher priority than the upgrade category, but lower priority than other information topic categories.

There are no specific limit on how many priority levels or categories that may be implemented for a subscriber account. New categories and priority levels can be created after the subscriber account is established. The category and priority level can be changed over time, either by the subscriber, or by the server system based on subscriber feedback from a large number of subscribers.

Also shown in Table 1, each information category or information topic can also be associated with an attention time window (ATW). The attention time window associated with an information topic category can be the default ATW for the information topic of that category. The duration of the attention time window for an information topic can indicate how long the information updates under the information topic remains valid, relevant, or important to the subscriber after its arrival. For example, the high alert, alert, news, promotions, and schedules typically are valid or relevant to the subscriber only for a few days. For example, a neighborhood crime report or daily news is typically only important or relevant for a few days. Traffic exceptions and weather exceptions may only be valid for a few hours. Updates may be valid for a few weeks, and can be dealt with any time within those few weeks. A critical alert that can have an indefinite attention time window because it is so critical that the subscriber pays attention to information updates under this category, the updates would not automatically expire until the subscriber has reviewed or otherwise dealt with it.

Another important attribute that can be associated with an information topic is the aging attribute of the information topic. Information topics of the same category can share a common aging attribute. The aging attribute can reflect the nature of the information topic in the sense that it indicates whether the information topic becomes more or less important over time.

For example, neighborhood crime reports, news, and updates tend to have declining importance and relevance as time goes by. On the other hand, reports on suspicious credit card activities, promotions, and schedules tend to become more important and relevant over time before they expire. As time goes by, it is more and more critical that the subscriber takes appropriate actions to address the report and or promotion or calendar events since delay may cause unwanted loss for the subscriber.

Table 1 also shows the notification schedules for each information topic category. The notification schedule can be used to determine when to send a notification to the subscriber after new information updates become available. Sometimes, subscribers do not wish to receive information updates immediately as the updates become available, since too many information updates can be distracting and disruptive. Some information updates warrant immediate attention, and the notification schedule for such information categories can be immediate upon arrival. Some information updates can have a more flexible notification schedule. For example, the user can specify periodic delivery of news, schedule items, promotions. The notification schedule for different information update category can differ depending on each subscriber's needs, interest, and availability. For example, the user can specify to receive news updates every morning, and promotions every other day. The notification schedule can be associated with each information topic and can be adjusted from time to time by the subscriber. A default notification schedule provided by the server system can be used as well, if the subscriber does not specify a personal notification schedule.

The priority associated with information topics can be used to organize information topics within each attention group. Information topics having the same priority can be grouped into priority groups, and the priority groups can be organized within each attention group according to the priority level. The higher priority topics can be listed higher within the attention group than the lower priority topics.

Each attribute (e.g., category, priority, ATW, aging attribute, notification schedule, and so on) associated with an information topic can be given a default value if the subscriber does not specify a different value for the attribute. The default value can be adjusted over time based on aggregated subscriber feedback. For example, if most subscribers associated a certain value to a certain attribute, the default value of the attribute can be selected to match that popular value.

After information topics are divided into attention groups based on their attention states, and each attention group is further divided into priority groups based on their priority attributes, information topics within each priority group can further be ordered by age. The age of an information topic may have different impacts on the position of the information topic within its attention and priority groups.

For some information topics, increased age increases importance and relevance, and moves the information topic higher within its attention and priority groups. The aging attribute of the information topic would indicate that the information topic is to ascend in ranking with age.

For some information topics, increased age decreases importance and relevance, and moves the information topic lower within its attention and priority groups. The aging attribute of the information topic would indicate that the information topic is to descend in ranking with age.

Some information topics have a finite attention time window (ATW), as the latest information update under the information topic ages beyond its ATW, the information topic expires. The attention state of the information topic changes to the Expired state, and the information topic is moved to the Expired attention group which is ranked lower in the attention list.

FIG. 5 is a flowchart illustrating an example process 500 for ordering information topics by age. As previously stated, the importance and relevance of an information update may increase or decrease with age, as denoted by an aging attribute of the information topic. If the information topic becomes more important with age (510), it will ascend in the attention list over time. Conversely, if the information topic becomes less important with age, it will descend in the attention list over time. For some information topics, age has no impact on the importance and relevance of the information topics. For such information topics, its position in the attention list does not change (e.g., always on top or at the bottom of its priority group).

When ranking the information topics, the server system can check the aging attribute of each information topic (510), if the information topic's aging attribute indicates ascending importance, a “compare time” can be set to be the timing lapsed (e.g., compare time=current time receipt time) (520). If the information topics' aging attribute indicates descending importance, the “compare time” can be set to be the time remaining (e.g., compare time=end of ATW−current time) (530). Once the “compare time” is evaluated for each information topic, then the information topics can be ranked in the order of decreasing “compare time.” The same process can be performed for each priority group within each attention group.

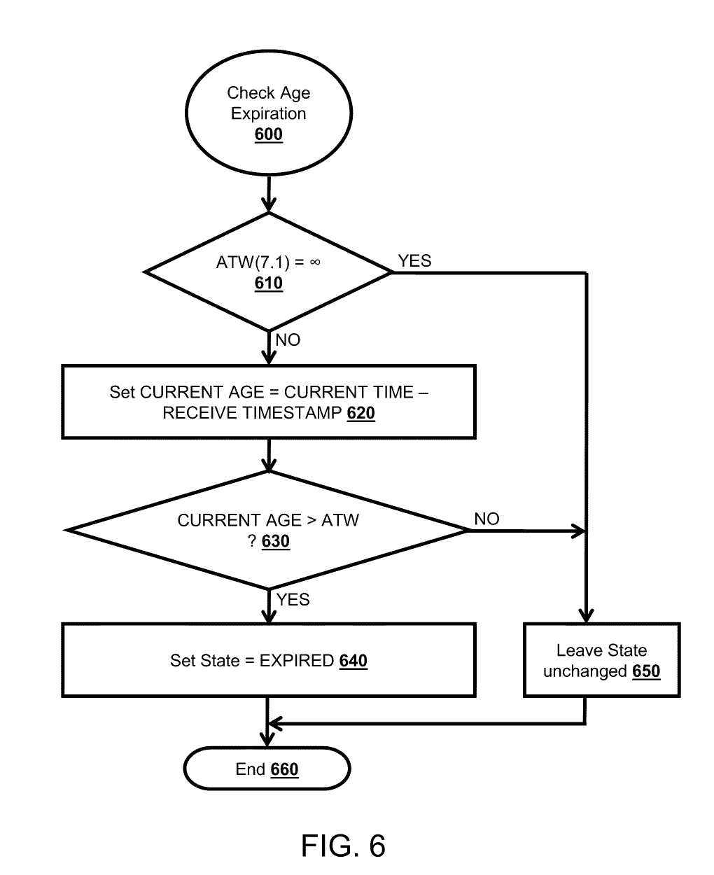

FIG. 6 is a flowchart illustrating an example process 600 for determining whether an information topic has expired due to its age. The age of an information topic can be defines by the age of its most recent information update. The information topic does not expired until the age of the most recent information update has exceeded the attention time window of the information topic.

First, it is determined whether the attention time window of the information topic is infinite (610), if the attention time window is infinite, the information topic does not expire due to age, and the attention state of the information topic can remain unchanged (650). If the attention time window of the information topic is finite, then the current age of the information topic can be computed. The current age of the information topic can be defined as the current age of the most recent information update of the information topic. The current age of the information update can be set to equal to the current time the receipt time for the most recent information update of the information topic (620). Then the current age of the information topic can be compared to the attention time window of the information topic (630). If the current age of the information topic exceeds the attention time window of the information topic, then the information topic has expired, and the attention state of the information topic can be reset to Expired (640). If the information topic's current age has not exceeded the attention time window of the information topic, then, the attention state of the information topic can remain unchanged. The process ends when the status of the information topic is determined (either expired or unexpired) (660).

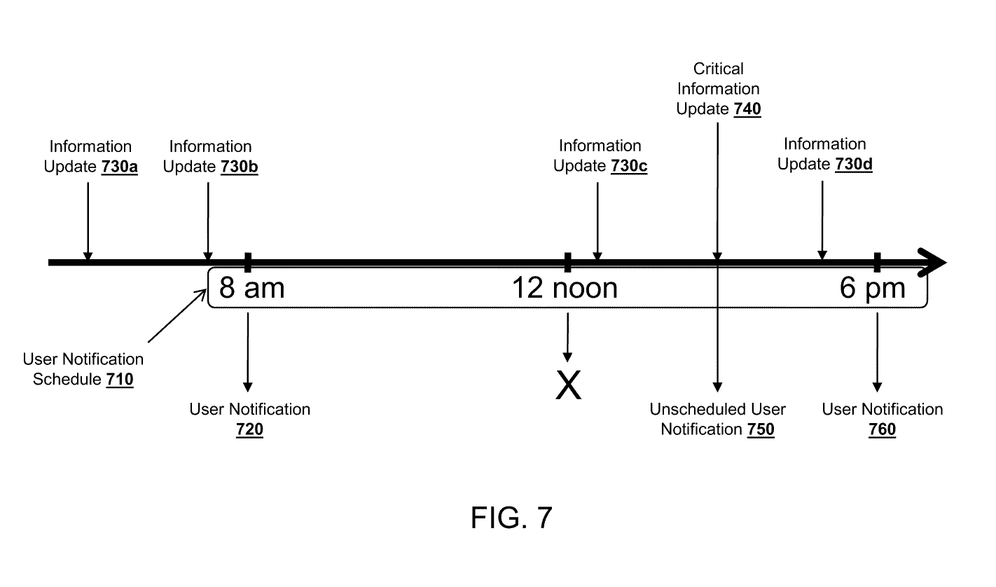

FIG. 7 illustrates an example user notification schedule. Notifications for information updates can be sent via email, SMS or other commonly available messaging system. Each subscriber can have a default or customized user notification schedule which defines when notifications should be delivered. A general notification schedule can apply to all information topics of a subscriber. Topic specific or category specific notification schedules can be defined that apply to only information updates of those topics and categories.

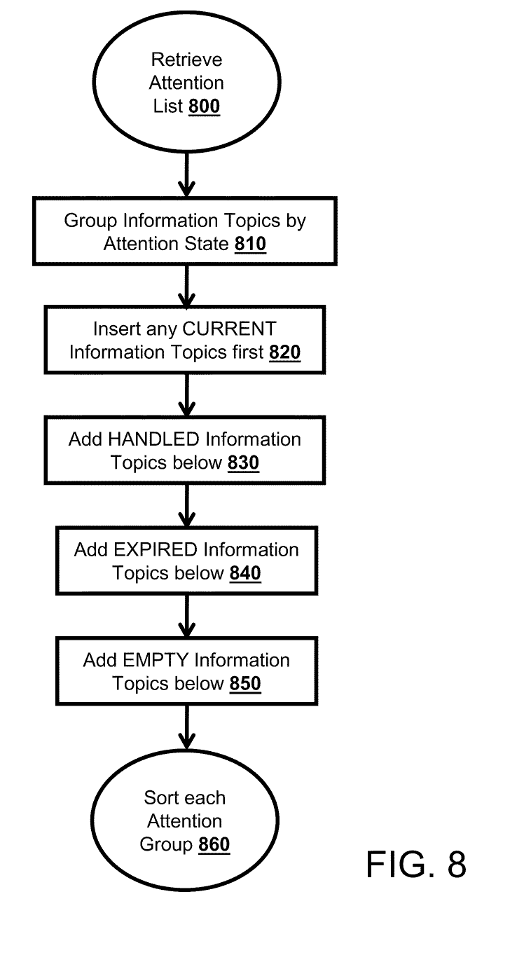

In the example shown in FIG. 7, the user has specified a notification schedule 710 that allows notification of information updates at 8 am, 12 noon, and 6 pm each day. In this example, two information updates (730a and 730b) have been received at different times prior to 8 am. A user notification 720 is generated for the new information updates 730a and 730b and delivered to the subscriber at 8 am. Between 8 am and 12 noon, there are no further information updates. Consequently, no user notification is generated (indicated by an “X” in FIG. 8). Around 3 pm, a critical information update 740 arrives. This information update belongs to the critical alert category and has a special notification schedule for immediate delivery. Therefore, an unscheduled user notification 750 is generated and delivered to the subscriber immediately. Between 12 noon and 6 pm, two more information update (730c and 730d) arrive, resulting in a scheduled user notification 760 delivered at 6 pm per the user notification schedule.

FIG. 8 illustrates an example process 800 for organizing an attention list according to attention groups when it is retrieved. Retrieval of the attention list can occur when the subscriber requests access to the attention list, at periodic intervals, or at other times, such as when a new information topic is to be added.

First, the information topics can be grouped by attention state (810). Example attention states are illustrated in FIGS. 4A and 4B. Information topics in the New attention group can be listed first in the attention list. Then information topics that are in the CURRENT attention group can be added to the attention list (820). Next, Information topics in the HANDLED attention group can be added to the attention list (830), followed by information topics in the EXPIRED attention group (850). Finally, information topics in the EMPTY attention group can be added to the attention list at the end (860). Once the information topics in the different attention groups are added to the attention list, the attention list is in the first order of organization—by attention state. The server can proceed to sort the information topics within each attention group 860 to achieve the second order of organization—by priority.

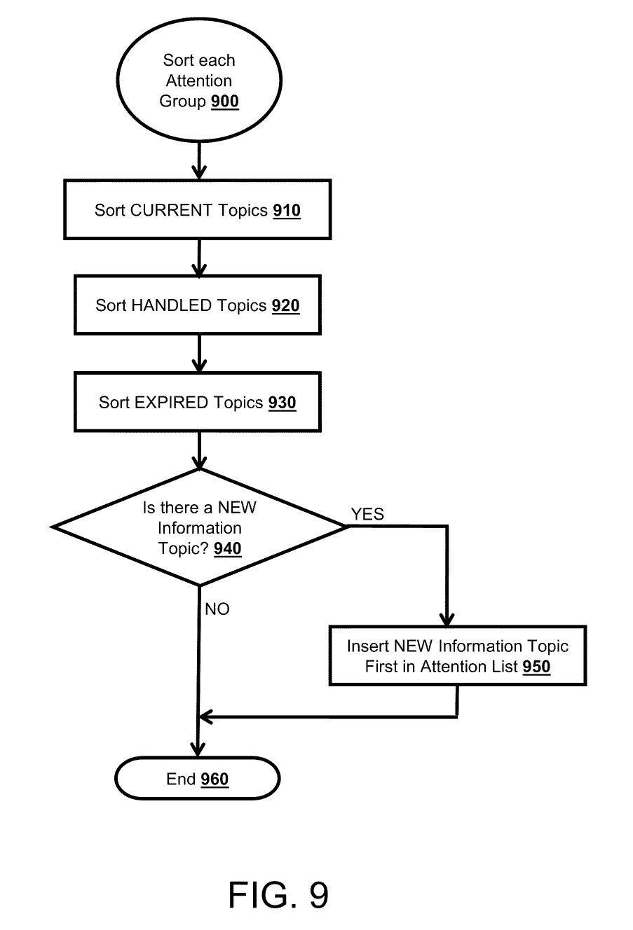

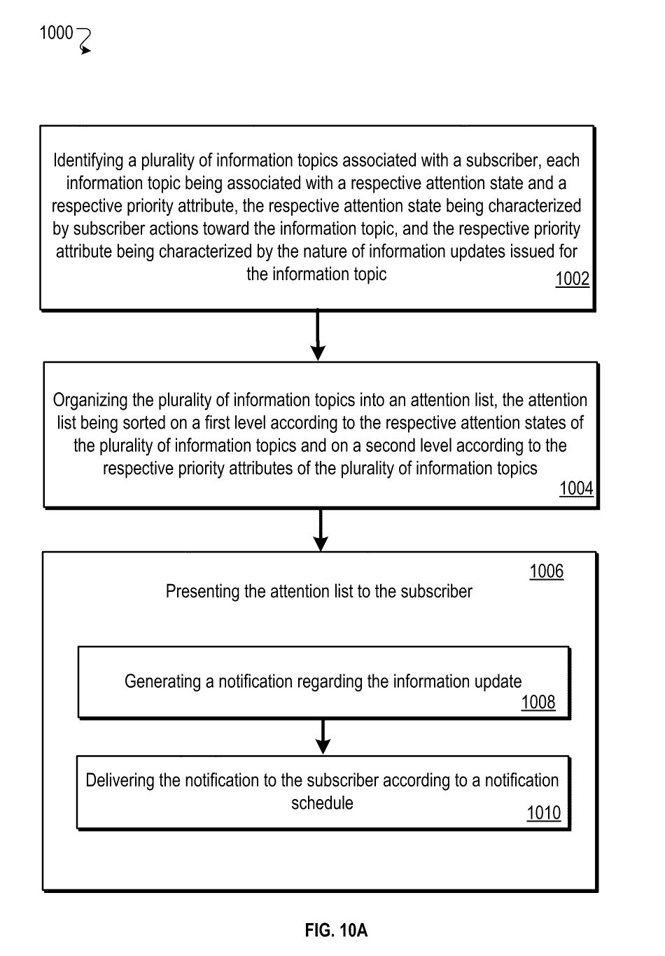

FIG. 9 illustrates an example process 900 for organizing each attention group according to priority and age. First the Current attention group can be sorted (910). Information topics within the Current attention group can be first divided into priority groups according to the priority attributes of the information topics. If multiple information topics have the same priority attribute, they can be further sorted according to their age and aging attributes. The “compare time” of each information topic can be calculated based on the method described with respect to FIG. 5. The information topics within each priority group can then be arranged in the order of increasing “compare time.”

Next, the Handled attention group can be sorted (920). The sorting can be performed in the same way as described with respect to the sorting of the Current attention group and in FIG. 6.

Next, the Expired attention group can be sorted (930). The sorting can be by priority first and then by age. The sorting by age can be based on the expiration time stamp instead of the “compare time.” Within the same priority group, the most recently expired information topic can be listed first (e.g., in a Last-In-First-Out (LIFO) order). In some implementations, the expired attention group can be sorted only by age without regard to priority.

The Empty attention group does not typically require sorting. In some implementations, the empty attention group can be sorted according to the subscription time of the information topics.

Finally, if there are New information topics (940), they can be added at the top of the attention list (950), with the most recently subscribed information topic listed first (950). Once all attention groups are sorted, the attention list can be presented to the subscriber (960). In some implementations, the total number of New information topics can be restricted. For example, the subscriber can be required to access the attention list once the total number of new information topics exceeds a predetermined threshold.

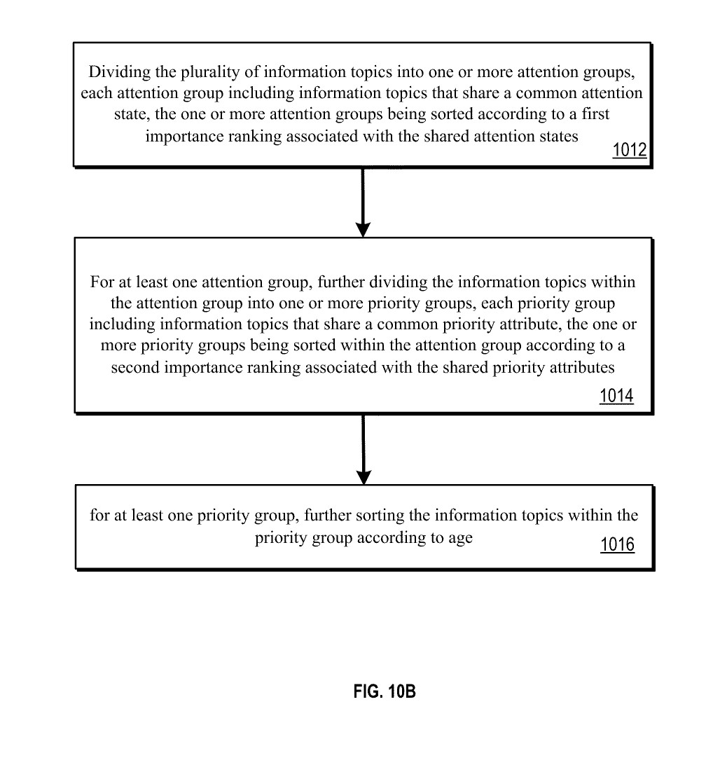

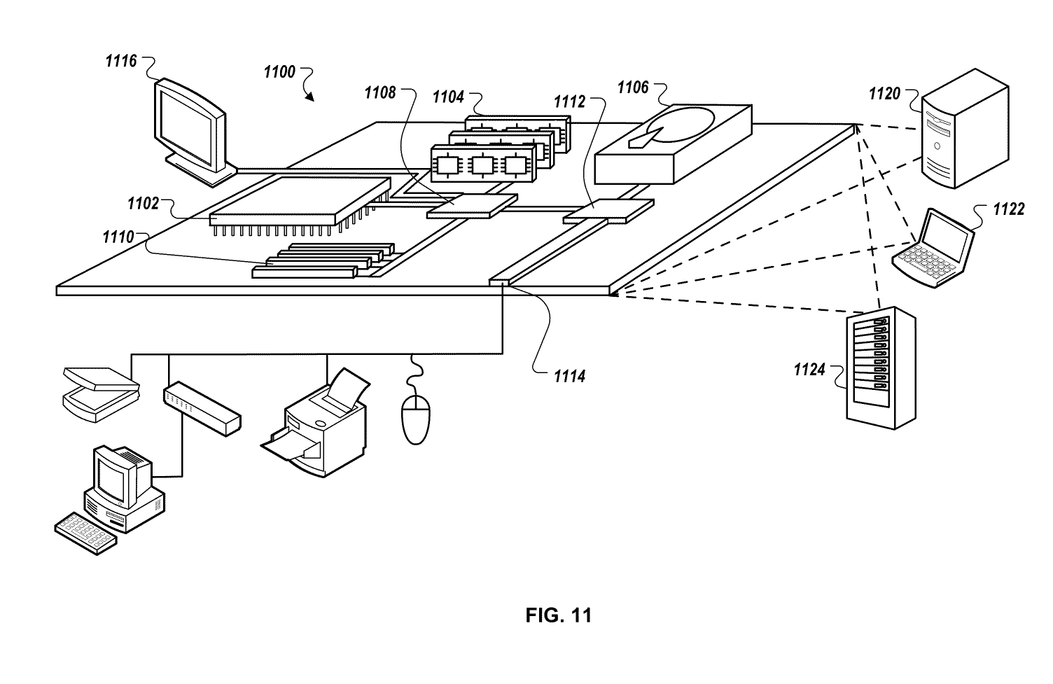

FIG. 10A illustrates an example process 1000 for delivering information updates to a subscriber. During this process, a number of information topics associated with the subscriber can be identified (1002). Each information topic can be associated with a respective attention state and a respective priority attribute. The respective attention state of each information topic can be characterized by subscriber actions toward the information topic (e.g., as described with respect to FIGS. 4A-4H). The respective priority attribute of each information topic can be characterized by the nature of information updates issued for the information topic. The nature of the information update can, for example, be reflected by the information topic category of the information topic (e.g., as described with respect to Table 1).

After the information topics associated with the subscriber are identified, the information topics can be organized into an attention list (1004). The attention list can be sorted on a first (primary) level according to the respective attention states of the information topics and on a second (secondary) level according to the respective priority attributes of the information topics. Then, the attention list can be presented to the subscriber (1006).

FIG. 10B illustrates an example process for organizing information updates in an attention list. First, the plurality of information topics can be divided into one or more attention groups, each attention group including information topics that share a common attention state (1012). The one or more attention groups can be sorted in the attention list according to a first importance ranking associated with the shared attention states. For example, the New attention state is ranked highest, the Current attention state is ranked higher than the Handled attention state, the Handled attention state is ranked higher than the Empty and the Expired attention states, and so on.

In some implementations, after the information topics are divided into attention groups, and the attention groups are sorted in the attention list, one or more attention groups can be further sorted according to priority (1014). For at least one attention group (e.g., the Current attention group), the information topics within the attention group can be further divided into one or more priority groups, each priority group including information topics that share a common priority attribute. The one or more priority groups can be sorted within the attention group according to a second importance ranking associated with the shared priority attributes.

In some implementations, each information topic can be further associated with a respective age, and organizing the plurality of information topics into the attention list can further take into account the age of the information topics. For at least one priority group (e.g., priority level 1), the information topics within the priority group are can be further sorted according to age (1016).

In some implementations, each information topic can be further associated with a respective aging attribute, the aging attribute defining how age impacts the importance or relevance of the information update (e.g., whether the order of the information topic is to increase or decrease with age, or remains the same regardless of age). The sorting within the priority group can be according to both the age and the aging attributes of the information topics within the priority group.

In some implementations, the age associated with each information topic is defined by an arrival time of a most recent information update for the information topic. For each information topic, it can be determined whether its most recent information update has expired. The age of the information update can be compared to an attention time window associated with the information update, and if the age exceeds the attention time window, the information topic is deemed to have expired. In some implementations, the attention time window associated with the information update can be user defined. In some implementations, the attention time window can be system defined. In some implementations, the attention time window can be adjustable over time by the system based on user feedback from multiple subscribers.

In some implementations, the priority attributes of the information topics can be adjusted overtime according to aggregated user feedback from multiple subscribers. For example, if most subscribers assign a certain priority to an information topic, then the default priority of the information topic can be adjusted to match that certain popular priority setting. The change in priority would be applied to subscriber accounts that rely on the system default priority value for the information topic.

In some implementations, notifications can be generated for information updates. For example, a notification can be generated regarding a newly arrived information update (1008). The notification can be delivered to the subscriber according to a notification schedule (1010).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

FIG. 11 is a block diagram of computing system 1100 that may be used to implement the systems and methods described in this document. System 1100 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing system 1100 includes a processor 1102, memory 1104, a storage device 1106, a high-speed interface 1108 connecting to memory 1104 and high-speed expansion ports 1110, and a low speed interface 1112 connecting to low speed bus 1114 and storage device 1106. Each of the components 1102, 1104, 1106, 1108, 1110, and 1112, are interconnected using various busses, and may be mounted on a common motherboard or in other manners as appropriate. The processor 1102 can process instructions for execution within the system 1100, including instructions stored in the memory 1104 or on the storage device 1106 to display graphical information for a GUI on an external input/output device, such as display 1116 coupled to high speed interface 1108. In other implementations, multiple processors and/or multiple buses may be used, as appropriate, along with multiple memories and types of memory. Also, multiple computing systems 1100 may be connected, with each device providing portions of the necessary operations (e.g., as a server bank, a group of blade servers, or a multi-processor system).

The memory 1104 stores information within the computing system 1100. In one implementation, the memory 1104 is a computer-readable medium. In one implementation, the memory 1104 is a volatile memory unit or units. In another implementation, the memory 1104 is a non-volatile memory unit or units.

The storage device 1106 is capable of providing mass storage for the computing system 1100. In one implementation, the storage device 1106 is a computer-readable medium. In various different implementations, the storage device 1106 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 1104, the storage device 1106, or memory on processor 1102.

The high speed controller 1108 manages bandwidth-intensive operations for the computing system 1100, while the low speed controller 1112 manages lower bandwidth-intensive operations. Such allocation of duties is exemplary only. In one implementation, the high-speed controller 1108 is coupled to memory 1104, display 1116 (e.g., through a graphics processor or accelerator), and to high-speed expansion ports 1110, which may accept various expansion cards (not shown). In the implementation, low-speed controller 1112 is coupled to storage device 1106 and low-speed expansion port 1114. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing system 1100 may be implemented in a number of different forms, as shown in the figure. For example, it may be implemented as a standard server 1120, or multiple times in a group of such servers. It may also be implemented as part of a rack server system 1124. In addition, it may be implemented in a personal computer such as a laptop computer 1122 or a mobile device (not shown). Alternatively, components from computing system 1100 may be combined with other components in a mobile device (not shown). Each of such devices may contain one or more of computing systems 1000, and an entire system may be made up of multiple computing systems communicating with each other.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
identifying a plurality of information topics associated with a subscriber, each information topic being associated with a respective attention state and a respective priority attribute, the respective attention state being characterized by subscriber actions toward the information topic, and the respective priority attribute being characterized by the nature of information updates issued for the information topic;
organizing, by a processor, the plurality of information topics into an attention list, the attention list being sorted on a first level according to the respective attention states of the plurality of information topics and on a second level according to the respective priority attributes of the plurality of information topics; and
presenting the attention list to the subscriber.

2. The method of claim 1, wherein organizing the plurality of information topics into the attention list further comprises:
dividing the plurality of information topics into one or more attention groups, each attention group including information topics that share a common attention state, the one or more attention groups being sorted according to a first importance ranking associated with the shared attention states; and
for at least one attention group, further dividing the information topics within the attention group into one or more priority groups, each priority group including information topics that share a common priority attribute, the one or more priority groups being sorted within the attention group according to a second importance ranking associated with the shared priority attributes.

3. The method of claim 2, wherein each information topic is further associated with a respective age, and organizing the plurality of information topics into the attention list further comprises:
for at least one priority group, further sorting the information topics within the priority group according to age.

4. The method of claim 3, wherein:
each information topic is further associated with a respective aging attribute, the aging attribute defining whether the order of the information topic is to increase or decrease with age; and
the sorting within the at least one priority group is according to both the age and the aging attributes of the information topics within the priority group.

5. The method of claim 3, wherein the age associated with each information topic is defined by an arrival time of a most recent information update for the information topic.

6. The method of claim 3, further comprising:
for each information topic, determining whether its most recent information update has expired, wherein the determining comprises comparing the age of the information update to an attention time window associated with the information update.

7. The method of claim 6, wherein the attention time window associated with the information update is user defined.

8. The method of claim 1, wherein each attention state is selected from a group comprising: a New state, a Current state, a Handled state, an Expired state, an Empty state, a Deleted state, and a Tentative state.

9. The method of claim 1, wherein the priority attributes of the information topics are adjusted overtime according to aggregated user feedback from multiple subscribers.

10. The method of claim 1, further comprising:
generating a notification regarding a newly arrived information update; and
delivering the notification to the subscriber according to a notification schedule.

11. A computer-readable medium, having instructions stored thereon, which, when executed by a processor, cause the processor to perform operations comprising:
identifying a plurality of information topics associated with a subscriber, each information topic being associated with a respective attention state and a respective priority attribute, the respective attention state being characterized by subscriber actions toward the information topic, and the respective priority attribute being characterized by the nature of information updates issued for the information topic;
organizing, by a processor, the plurality of information topics into an attention list, the attention list being sorted on a first level according to the respective attention states of the plurality of information topics and on a second level according to the respective priority attributes of the plurality of information topics; and
presenting the attention list to the subscriber.

12. The computer-readable medium of claim 11, wherein organizing the plurality of information topics into the attention list further comprises:
dividing the plurality of information topics into one or more attention groups, each attention group including information topics that share a common attention state, the one or more attention groups being sorted according to a first importance ranking associated with the shared attention states; and
for at least one attention group, further dividing the information topics within the attention group into one or more priority groups, each priority group including information topics that share a common priority attribute, the one or more priority groups being sorted within the attention group according to a second importance ranking associated with the shared priority attributes.

13. The computer-readable medium of claim 12, wherein each information topic is further associated with a respective age, and organizing the plurality of information topics into the attention list further comprises:
for at least one priority group, further sorting the information topics within the priority group according to age.

14. The computer-readable medium of claim 13, wherein:
each information topic is further associated with a respective aging attribute, the aging attribute defining whether the order of the information topic is to increase or decrease with age; and
the sorting within the at least one priority group is according to both the age and the aging attributes of the information topics within the priority group.

15. The computer-readable medium of claim 13, wherein the age associated with each information topic is defined by an arrival time of a most recent information update for the information topic.

16. A system, comprising:
one or more processors; and
memory coupled to the one or more processors, the memory having instructions stored thereon, which, when executed by the one or more processors, cause the one or more processors to perform operations comprising:
identifying a plurality of information topics associated with a subscriber, each information topic being associated with a respective attention state and a respective priority attribute, the respective attention state being characterized by subscriber actions toward the information topic, and the respective priority attribute being characterized by the nature of information updates issued for the information topic;
organizing, by a processor, the plurality of information topics into an attention list, the attention list being sorted on a first level according to the respective attention states of the plurality of information topics and on a second level according to the respective priority attributes of the plurality of information topics; and
presenting the attention list to the subscriber.

17. The system of claim 16, wherein organizing the plurality of information topics into the attention list further comprises:
dividing the plurality of information topics into one or more attention groups, each attention group including information topics that share a common attention state, the one or more attention groups being sorted according to a first importance ranking associated with the shared attention states; and
for at least one attention group, further dividing the information topics within the attention group into one or more priority groups, each priority group including information topics that share a common priority attribute, the one or more priority groups being sorted within the attention group according to a second importance ranking associated with the shared priority attributes.

18. The system of claim 17, wherein each information topic is further associated with a respective age, and organizing the plurality of information topics into the attention list further comprises:
for at least one priority group, further sorting the information topics within the priority group according to age.

19. The system of claim 18, wherein:
each information topic is further associated with a respective aging attribute, the aging attribute defining whether the order of the information topic is to increase or decrease with age; and
the sorting within the at least one priority group is according to both the age and the aging attributes of the information topics within the priority group.

20. The system of claim 18, wherein the age associated with each information topic is defined by an arrival time of a most recent information update for the information topic.
